(19) United States
(12) Patent Application Publication
(10) Pub. No.: US 2010/0002147 A1
(43) Pub. Date: Jan. 7, 2010

(54) METHOD FOR IMPROVING THE DERINGING FILTER

(75) Inventor: Doron Sabo, Natanya (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: Horizon Semiconductors Ltd., Herzliya (IL)

(21) Appl. No.: 12/166,363

(22) Filed: Jul. 2, 2008

(51) Int. Cl. H04N 5/911

(52) U.S. Cl. 348/625; 348/E05.064

(57) ABSTRACT

The present invention relates to a method for filtering ringing artifacts in a reconstructed pixel edge block comprising the steps of: (a) providing said edge block; (b) determining a threshold as a function of the pixel values in said edge block; (c) mapping each pixel, of said edge block, to a corresponding binary index according to its value and said threshold; (d) scanning using a window, a first binary index of said mapped edge block and its surrounding indices; (e) determining if all entrapped binary indices of said window are uniform; (f) if not all entrapped binary indices of said window are uniform, scanning using a sub window that entraps said first binary index, within said window, for determining if all entrapped binary indices of said sub window are uniform; and (g) if all entrapped binary indices of said sub window are uniform, filtering the pixel that corresponds to said first binary index with the pixel values that correspond to the binary indices entrapped in said sub window.

### FIELD OF THE INVENTION

The present invention relates to the field of video image decoding. More particularly, the invention relates to a method for preserving image edges and removing the ringing artifacts from decoded video data.

### BACKGROUND OF THE INVENTION

Over the years, various techniques of compression have been explored for compressing video signals. These techniques are typically lossy in their nature, that is, they attempt to use a lesser amount of bits to represent the most important information present in the image data, such that most viewers of the decoded video signal will find it difficult to detect the differences between the decoded video signal and the original non-coded signal.

One of the popular forms of compression is to apply transformation to the digital signal, effectively transforming the digital signal from the spatial domain to another domain (e.g. the frequency domain). The idea behind this is to exploit the energy compaction property of the transformation, so that redundancy in the image can be removed more efficiently in the transformed domain.

Various transformation techniques have been explored for the removal of redundancy in the spatial domain, and Discrete Cosine Transform (DCT) is found to be the best transformation, taking into account efficiency and implementation complexity. Thus, DCT has been the basic core technique of a few established International Standardization Organization (ISO) standards for the compression of images, which include JPEG (Joint Photographic Expert Group), MPEG (Moving Picture Expert Group) Phase-1, MPEG Phase-2, and h.261.

To compress an image using the DCT transform, the image is first divided into square blocks of pixels (e.g. 8×8 pixel blocks) and each of these blocks is then transformed using DCT into a transformed block which contains the DCT coefficients. As the neighboring pixels in an image are in general highly correlated, this enables the DCT to transform image pixel into coefficients that are energy concentrated around the top-left corner of the transformed block, which is the low frequency region. These transformed blocks are then quantified into quantized coefficients and then run-length and variable length coded to further reduce the statistical redundancy present into the run-length coded data.

As described above, the energy compaction property of DCT can be easily applied to a block of pixels that are highly correlated. However, in the case of a block displaying an edge, i.e. a block which contains sharp changes in intensity and/or color of neighboring pixels, referred to hereinafter as an edge block, the compaction of signal energy is not achieved efficiently. Furthermore, in order to compress more bits, the Quantization parameters are designed to preserve the low frequency coefficients at the upper left corner of the block, this design will generate error for an edge block when the edge block is transformed and coded. The error will cause a ringing effect (corona effect) appearing near the edge of the reconstructed block. This ringing effect infuses noise in the high frequency area of the decoded video signal, effectively adding unwanted distortions to the reconstructed image. In other words, ringing is a correlated noise appearing near distinctive edges.

Ringing occurs when coarse quantization of DCT coefficients, especially of high frequency AC coefficients, introduces noise. In higher quality (i.e. lower compression ratio) systems, ringing is the most visible artifact. Due to slight variations from frame to frame, ringing noise is visible in moving pictures as a local flickering near edges, as edge information is very sensitive to the human eyes compared to other high frequency pixel regions. This type of noise is also known as “mosquito noise”.

U.S. Pat. No. 6,993,191 describes a method applying a deringing filter for preserving image edges in video frames. The described method applies a 9-tap low-pass filter to an adaptive processing window. The filter window is initialized with the values in a 3×3 mask centered on the position whose output is computed. Then, all values that are very different from the central one are replaced with the central value before the filter is applied. However, the disclosed method grants a huge weight to the center value of the 3×3 mask as all the values that are very different from the center are replaced with this central value, this may cause in some of the cases a distortion in the image.

It is an object of the present invention to provide an efficient filter for edge blocks.

It is another object of the present invention to provide a filter for preserving image edges and eliminating the ringing artifacts in decoded images.

It is still another object of the present invention to provide a method for enhancing the view quality of the decoded image.

Other objects and advantages of the invention will become apparent as the description proceeds.

### SUMMARY OF THE INVENTION

The present invention relates to a method for filtering ringing artifacts in a reconstructed pixel edge block comprising the steps of: (a) providing said edge block; (b) determining a threshold as a function of the pixel values in said edge block; (c) mapping each pixel, of said edge block, to a corresponding binary index according to its value and said threshold; (d) scanning using a window, a first binary index of said mapped edge block and its surrounding indices; (e) determining if all entrapped binary indices of said window are uniform; (f) if not all entrapped binary indices of said window are uniform, scanning using a sub window that entraps said first binary index, within said window, for determining if all entrapped binary indices of said sub window are uniform; and (g) if all entrapped binary indices of said sub window are uniform, filtering the pixel that corresponds to said first binary index with the pixel values that correspond to the binary indices entrapped in said sub window.

Preferably, the window is a square window of M*M.

In one embodiment, the window is a triangular window of M*N.

Preferably, the window is square window of 3*3.

Preferably, the sub window is a square window of M*M.

In one embodiment, the sub window is a triangular window of M*N.

Preferably, the sub window is square window of 2*2.

Preferably, the scanning using a sub window is applied more than once.

In one embodiment, the scanning using a sub window is applied using different sizes of sub windows.

### BRIEF DESCRIPTION OF THE DRAWINGS

In the drawings:

FIG. 1 depicts an example of a pixel edge block, its reconstructed pixel edge block and the corresponding binary mapped block.

FIG. 2 depicts an example of a binary map and the scanning method of 3×3 windows, according to a prior art deringing method.

FIG. 3a depicts an example of scanning using a 2×2 sub window within a scanned 3×3 window, according to an embodiment of the invention.

FIG. 3b depicts an example of scanning using another 2×2 sub window within a scanned 3×3 window, according to an embodiment of the invention.

FIG. 3c depicts an example of a 2×2 filter, according to one of the embodiments.

### DETAILED DESCRIPTION OF PREFERRED EMBODIMENTS

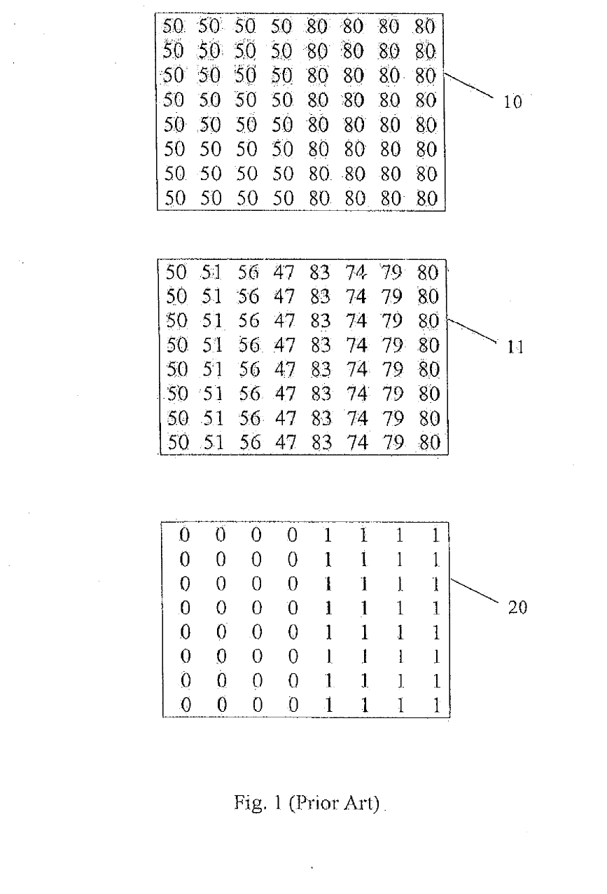

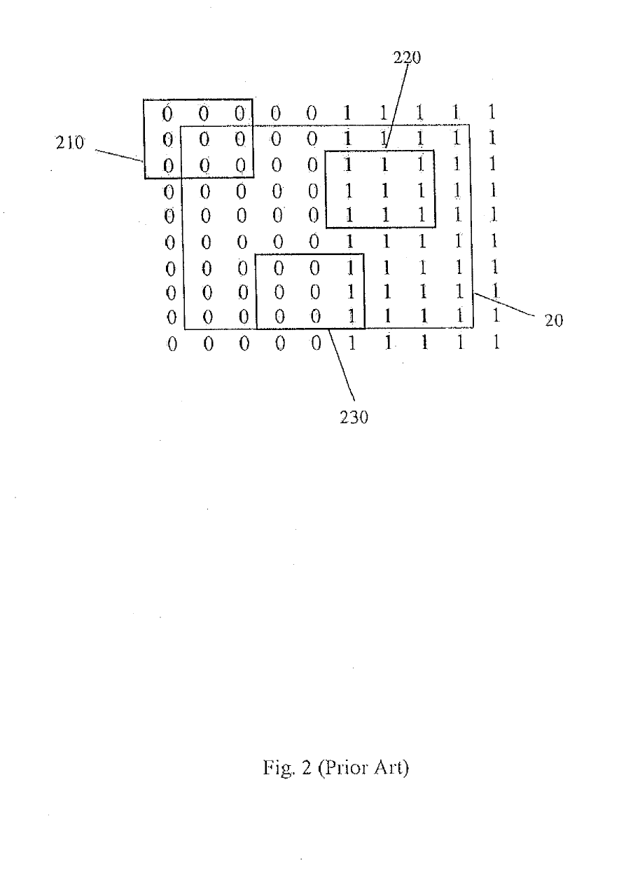

FIG. 1 depicts an example of a pixel edge block 10, its reconstructed pixel edge block 11, i.e. after inverse transformation back to the spatial domain, and the corresponding binary mapped block 20. An edge block is a block of pixels that displays an edge, i.e. a block which contains sharp changes in neighboring pixel values, such as pixel edge block 10 which displays a clear edge between the block's left side pixel values which are 50 and the block's right side pixel values which are 80. The sharp change in neighboring pixel values may be a sharp change in any component of the pixel, e.g. in an YC_{b}Cᵣ representation the sharp change may be in any one of the components Y, C_{b} or Cᵣ. The edge, i.e. sharp change, may be a function of the pixels values within the image and the encoding parameters, such as Quantization parameter. The edge may also be calculated differently for the different components of the pixel. In one embodiment a difference of 20 between neighboring pixel values is considered an edge. After the edge block 10 had been transformed, coded, decoded and inverse transformed, the pixel values have been distorted and ripples appear on both side of the edge, effectively constituting the ringing artifacts, as shown in the corresponding reconstructed block 11. As stated above, these ringing artifacts are an inherent part of the DCT transformation and inverse transformation of edge blocks. In order to minimize these ringing artifacts MPEG-4 standard (ISO/IEC 14496-2) Appendix F.3.2 suggests and discloses a deringing method and filter. This prior art deringing method comprises three steps: (i) threshold determination, (ii) index mapping, and (iii) adaptive smoothing, which can be applied to the pixels on an image block, e.g. an 8×8 pixel image block. As described in the standard, the first step is applied by determining a threshold as a function of minimum and maximum pixel values in each block. An example of such a formula can be found in the standard (ISO/IEC 14496-2 Third edition 2004-06-01 Appendix F.3.2.1). The second step is applied by mapping each pixel value to a corresponding binary index (0 or 1) according to its value, compared to the calculated threshold. For example, block 20 maps the pixel values of block 11 to corresponding binary indices compared to the calculated threshold, which in this example may be 65. As shown, each pixel in block 11 is binary mapped in block 20 corresponding to its place in block 11. The third step is applied by filtering and smoothing the pixel values, and will be described below in relations to FIG. 2.

The terms pixel(s) and pixel value(s) in all of their forms are used throughout the present specification and claims interchangeably.

FIG. 2 depicts an example of a binary map and the window scanning method used for filtering and applying the third step of the prior art deringing method. Binary block 20 is the binary mapping of the pixel block 11 as described in relations to FIG. 1. The binary indices adjacent to block 20 are the binary indices of the adjacent pixels of block 11 in the image. For the sake of brevity the following description deals with a single pixel in the upper left side of block 20; however, the following process is applied to each pixel, in the block 20 and in the other blocks of the image. At first, a scanning using a 3×3 window 210 is applied to the mapped binary index in the upper left side of block 20 and to the mapped indices surrounding it. The terms window(s), and sub window(s), are used throughout the description to define a range or an area of which the pixels or binary indices entrapped within are of interest. Thus all referrals hereinafter to a pixel/binary index and its surrounding pixels/binary indices it is meant to include the entrapped pixels or binary indices entrapped within the window. At this stage the scanned indices entrapped within the 3×3 window 210 are processed. If all the binary indices within the 3×3 window 210 share the same values, i.e. are uniform, a filter is applied to the pixels represented by the binary indices entrapped in the 3×3 window 210. Since all the binary indices entrapped in window 210 are uniform, a filter can be applied for smoothing the pixel represented by the binary index in the center of window 210, i.e. the most upper left pixel of the pixel edge block 11. The applied filter uses the values of pixels represented by the binary indices entrapped within window 210 for filtering and smoothing the pixel represented by the binary index in the center of window 210. Such a filter is described in the standard ISO/IEC 14496-2 Third edition 2004-06-01 Appendix F.3.2.3.1, however, any known filter may be used for smoothing the central pixel with its surrounding pixels. Nevertheless, if not all the binary indices in the scanned 3×3 window are uniform, such as the case in window 230, the pixel, represented by the binary index in the center of the window, cannot be filtered with its surrounding pixels at this stage. Thus, the pixel, represented by the binary index in the center of a window that entrap indices of an edge, may not filtered and smoothed, according to the suggested prior art method. As stated above, the most upper left pixel of block 11, which is binary represented by the most upper left binary index of block 20, is filtered with its close surrounding pixels, i.e. the pixels that are represented by indices entrapped within block 210, as all the mapped binary indices in the window 210 are uniform. Similarly, window 220 also entraps binary indices with the same value and thus the pixel represented by the center binary index of window 220 is also filtered with its surrounding pixels as well. However, the pixels near the displayed edge are not filtered at this point, such as the pixel represented by the center binary index of window 230, since not all the entrapped mapped indices have the same value.

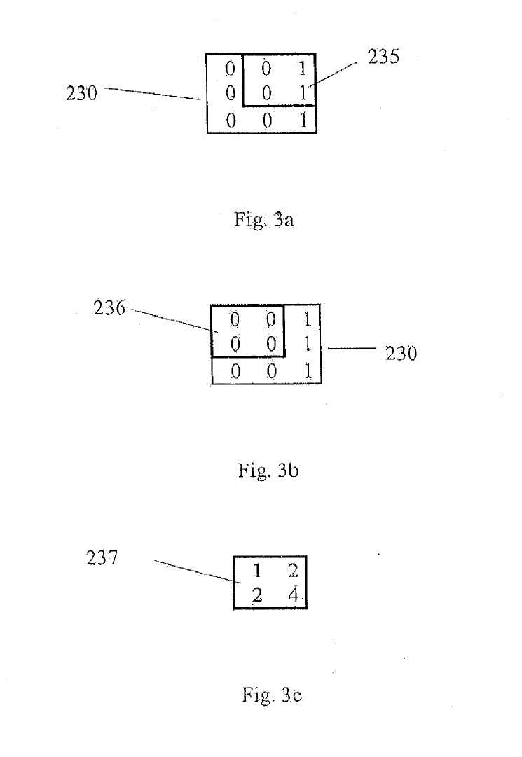

FIGS. 3a and 3b depict the method of scanning using 2×2 sub windows within scanned 3×3 windows, according to an embodiment of the invention. As described in relations to FIG. 2, window 230 is a 3×3 window entrapping the binary indices representations of a 3×3 pixel edge block. As described, no filter has yet been applied to the central pixel represented by the center binary index of the window 230, since not all the binary indices of the window 230 are the same. At this stage a scanning using a 2×2 sub window is commenced within the scanned window 230, and only if all the binary indices entrapped within this sub window share the same values, i.e. are uniform, is a filter applied. If not, another scanning using a different 2×2 sub window is applied within window 230, until a suitable scanning of a 2×2 window is found or until all four scanning possibilities have been tried and failed. For example, at first an upper right 2×2 window 235 can be scanned as shown in FIG. 3a. However, since the entrapped indices in sub window 235 are not all uniform a new scanning using another sub window is needed. In FIG. 3b a second example is depicted where the scanning of a 2×2 window 236 entraps only binary indices sharing the same value. When a suitable scanned 2×2 window is found, such as window 236, a 2×2 filter is applied using the pixel values represented by the binary indices of window 236, in order to smooth the central pixel of window 230. An example of such a 2×2 filter is shown in FIG. 3c as filter 237, although any 2×2 filter may be used according to the needs and requirements. In one embodiment, the 2×2 filter is redesigned each time specifically in accordance with the processed sub window. If window 236 would have been found to be unsuitable, the two other possibilities (lower right and lower left 2×2 windows) would have been checked one by one.

As described above, the method of the invention not only provides a hierarchical process for resizing filters for specific matching; it also allows filtering a pixel with an exclusively selective group of pixels. The hierarchical process of the invention, as described, utilizes filters of different sizes in order to specifically match the right sized filter for smoothing each pixel of the decoded image. Thus some of the pixels in the image may be filtered using one size filter while other pixels of the same image may be filtered using a different size filter, in accordance with their different position and arrangement in the image. The second benefit of the method is received from the exclusive selecting of the pixels closer in value for the filter. The described process eventually causes the edge pixels, i.e. the pixels close to the edge, to be filtered with pixels that are physically close and closer in value, without processing the other physically close pixels on the other side of the edge which vary sharply in value. Thus the edge does not smear and the ringing artifacts can be filtered.

The window and sub window of the described scanning technique may belong to any square (M*M) or rectangle (M*N) arrangement as long as the sub window entraps a smaller area of the window. In other words: if the window's area is M*N (where M is the length of the window and N is the width of the window) and the sub window's area is I*J (where I is the length of the sub window and J is the width of the sub window) then the following condition has to be met:

M≧I and N≧J and (M*N>I*J).

In one of the embodiments, the invention may be carried out using different sizes and arrangements of pixel blocks, windows, sub windows, filters, and any number of stages. For example, after a certain size pixel block is binary mapped, a scanning using a 5×5 window can be applied around the binary indices, and thus a 5×5 filter may be used for better filtering. The 5×5 filter can then be used when all the binary indices in the 5×5 window are uniform, i.e. not on edge blocks. Thus a pixel value can be filtered with all 24 pixel values that surround it. However, the 5×5 edge windows are processed separately by scanning using sub windows within the 5×5 edge block. At first scanning using 4×4 sub windows may be tried. If a suitable 4×4 block is not found, i.e. that all four possible 4×4 blocks do not entrap uniform binary indices, then another stage of scanning using smaller sub windows may be applied, such as 3×3, and so on. The process may be repeated until a suitable sub window is found as long as the central binary index of the window is entrapped in the scanned sub window. When a suitable sub window is found a filter may be applied accordingly as described. Thus the hierarchical process may be utilized in any number of stages. In another embodiment, the scanning using 2×2 sub windows may be used first (as the second stage of the process) within the 5×5 edge window without first gradually downsizing the sub window of the scanning.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for filtering ringing artifacts in a reconstructed pixel edge block comprising the steps of:
a. providing said edge block;
b. determining a threshold as a function of the pixel values in said edge block;
c. mapping each pixel, of said edge block, to a corresponding binary index according to its value and said threshold;
d. scanning using a window, a first binary index of said mapped edge block and its surrounding indices;
e. determining if all entrapped binary indices of said window are uniform;
f. if not all entrapped binary indices of said window are uniform, scanning using a sub window that entraps said first binary index, within said window, for determining if all entrapped binary indices of said sub window are uniform; and
g. if all entrapped binary indices of said sub window are uniform, filtering the pixel that corresponds to said first binary index with the pixel values that correspond to the binary indices entrapped in said sub window.

2. A method according to claim 1, where the window is a square window of M*M.

3. A method according to claim 1, where the window is a triangular window of M*N.

4. A method according to claim 2, where the window is square window of 3*3.

5. A method according to claim 1, where the sub window is a square window of M*M.

6. A method according to claim 1, where the sub window is a triangular window of M*N.

7. A method according to claim 5, where the sub window is square window of 2*2.

8. A method according to claim 1, where the scanning using a sub window is applied more than once.

9. A method according to claim 8, where the scanning using a sub window is applied using different sizes of sub windows.
